(19) United States
(12) Patent Application Publication
(10) Pub. No.: US 2025/0089900 A1
(43) Pub. Date: Mar. 20, 2025

(54) SWITCHABLE MODE GRAVITY-SENSING HEATED SEAT CUSHION

(71) Applicant: Changzhou Wenxin Intelligent Technology Co., Ltd., Changzhou (CN)

(72) Inventor: KAI WANG, Changzhou (CN)

(21) Appl. No.: 18/482,894

(22) Filed: Oct. 8, 2023

(30) Foreign Application Priority Data
Sep. 15, 2023 (CN) 202322515809.5

(51) Int. Cl. A47C 7/74; A47C 7/02; H05B 1/02

(52) U.S. Cl. CPC A47C 7/748; H05B 1/0222; A47C 7/021

(57) ABSTRACT

A switchable mode gravity-sensing heated seat cushion, including: seat cushion cover; switch; The switch is arranged on the right side of the seat cushion cover. The switch is provided with an on/off button. The switch is provided with a temperature adjustment button; a The gravity-sensing heating plate is provided on the seat cushion cover. The inside of the seat cushion cover is provided with a pressure thin film, the pressure thin film is bottom of the gravity-sensing heating plate and the inside of the seat cushion cover is filled with filler. The switchable mode gravity-sensing heated seat cushion provided by the invention can avoid manual forgetting to turn off and avoid power loss, and can switch between manual adjustment and automatic induction adjustment. Through the change of the indicator light assembly on the switch, the adjustment button can be hand/automatic mode.

### CROSS REFERENCE TO RELATED APPLICATIONS

The present application claims the priority of Chinese patent application No. 202322515809.5, filed on Sep. 15, 2023, and contents of which are incorporated herein by its entireties.

### TECHNICAL FIELD

The present disclosure relates to the seat cushions, especially to a gravity induction heating seat cushion with switchable modes.

### BACKGROUND

For consumer, the seat cushion may be just a soft support material used to support the buttocks when sitting down. The soft nature of the seat cushion itself is used to provide a more comfortable support effect for the user's buttocks.

Heated seat cushion with switch in the current technology, through the USB interface, it can be used in combination with power banks, car power supplies, computers, sockets, etc., so that it can be taken on the go and travel easily. In the cold season, it can keep people warmer during outdoor activities.

However, such a heated cushion needs to be turned off manually when not in use, which may cause power loss due to frequent forgetting to turn off the power, thus shortening the heating time.

Therefore, This invention provides a switchable mode gravity-sensing heated seat cushion to solve the above technical problems.

### SUMMARY

The present disclosure provides a switchable mode gravity-sensing heated seat cushion, which solves the above problem.

In order to solve the above technical problems, the invention provides a switchable mode gravity-sensing heated seat cushion, comprise: seat cushion cover; switch; gravity-sensing heating plate.

Said switch is arranged on the seat cushion cover, There is an on/off button on the switch, similarly, there is a temperature adjustment button on the switch;

Said gravity-sensing heating plate is arranged in the seat cushion cover, There is an pressure thin film in the seat cushion cover, Said pressure thin film located at the bottom of the gravity-sensing heating plate, Said seat cushion cover is filled with filler.

In some embodiment, the top of the switch is equipped with an indicator light assembly, The indicator light assembly includes a white light and a temperature light, and both the white light and the temperature light are installed on the top of the switch.

In another embodiment, The bottom of the switch is provided with a power interface, wherein the power interface has a wire, and the power interface is used to connect to an external power supply to realize the power supply function, the power interfaces not limited to USB interfaces, type C, DC and other interfaces.

In another embodiment, The shape of the seat cushion cover is one of square, rectangle, circle, and triangle.

In another embodiment, The exterior of the seat cushion cover is provided with a waterproof coating.

Compared with the related techniques, the invention replaces switchable mode gravity-sensing heated seat cushion which has the following beneficial effects as follow:

The present disclosure provides the switchable mode gravity induction heating cushion starts the cushion heating through gravity induction. As soon as a person sits on it, the pressure switch is triggered and the cushion begins to heat. When the person leaves the cushion, that is, after there is no pressure on the cushion, it enters a non-heating state, which can avoid manual forgetting turn off to avoid power loss, and can switch between manual adjustment and automatic induction adjustment. Through the change of the indicator light component on the switch, the manual and automatic modes are distinguished, making it more convenient to use the seat cushion.

### BRIEF DESCRIPTION OF DRAWINGS

FIG. 1 is a structural diagram of a preferred embodiment of a switchable mode gravity-sensing heated seat cushion;

FIG. 2 is a schematic side view of the switch shown in FIG. 1;

FIG. 3 is control block diagram of switchable mode gravity-sensing heated seat cushion;

In the FIG., the representation of each reference sign is as follows.

1, seat cushion cover; 2, switch; 3, on/off button; 4, temperature adjustment button; 5, gravity-sensing heating plate; 6, pressure thin film; 7, filler; 8, light assembly; 81, white light; 82, temperature light; 9, power interface.

### DETAILED DESCRIPTION

Implementations of the present disclosure will now be described, by way of embodiments only, with reference to the drawings. It should be understood that the specific embodiments described here are only used to explain but not to limit the present application. Based on the embodiments in the present application, all other embodiments obtained by one ordinary skill in the art without creative labor is within the scope of the present application.

The invention is further explained below in combination with the attached drawings and the embodiment.

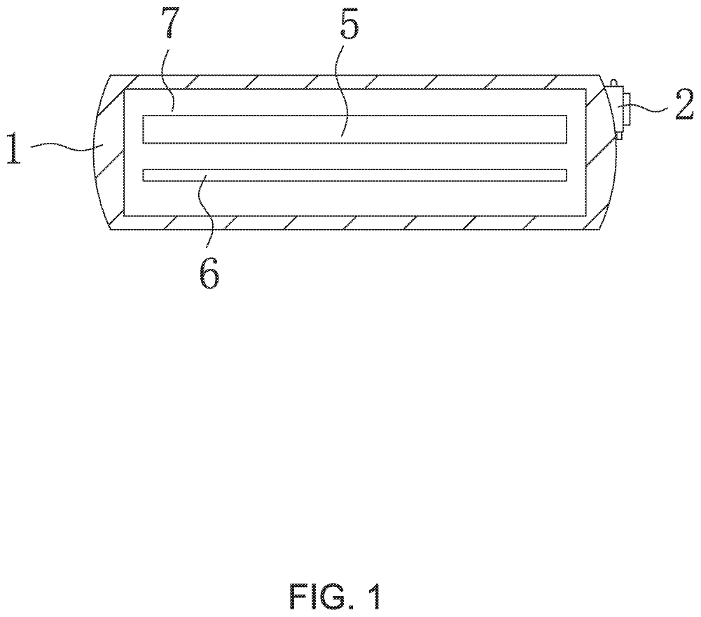

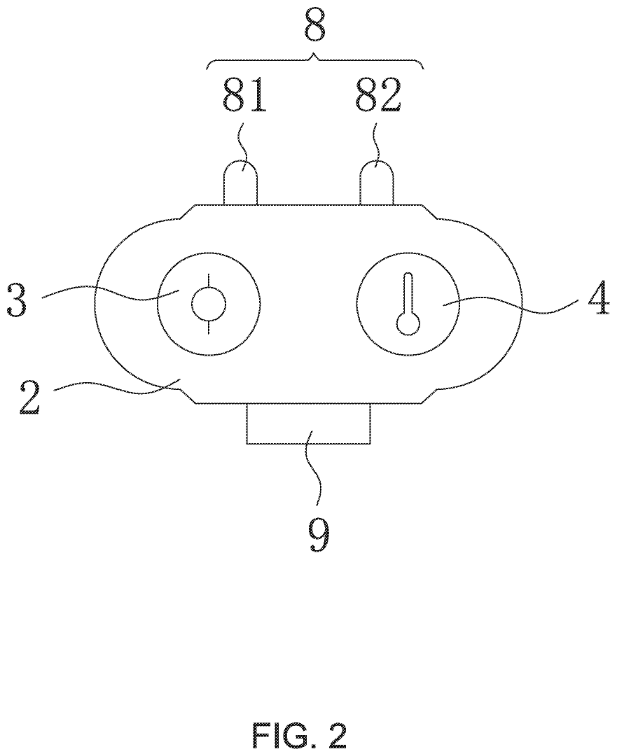

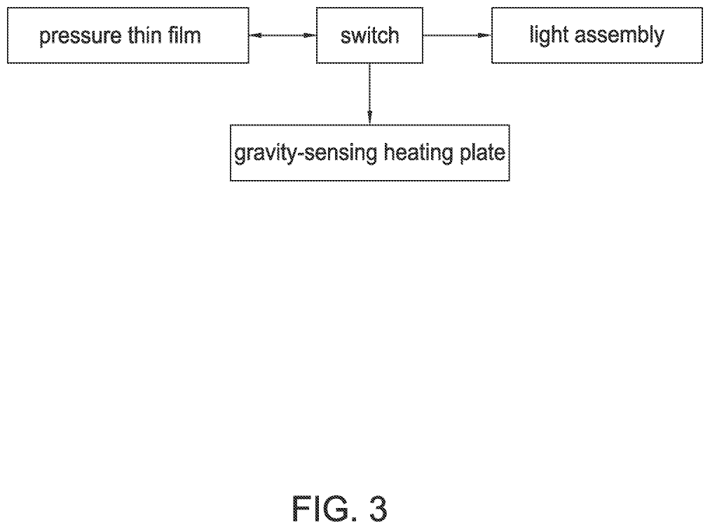

Referring to FIG. 1-3, FIG. 1 is a structural diagram of a preferred embodiment of a switchable mode gravity-sensing heated seat cushion; FIG. 2 is a schematic side view of the switch shown in FIG. 1; FIG. 3 is control block diagram of switchable mode gravity-sensing heated seat cushion.

A switchable mode gravity-sensing heated seat cushion, which comprise:

Seat cushion cover 1 and switch 2, The switch 2 is provided on the seat cushion cover 1. The switch 2 is provided with on/off button 3. The switch 2 is provided with a temperature adjustment button 4;

The gravity-sensing heating plate 5 is arranged inside the seat cushion cover 1, and a pressure thin film 6 is provided inside the seat cushion cover 1. The pressure thin film 6 is located at the bottom of the gravity-sensing heating plate 5. The interior of the seat cushion cover 1 is filled with filler 7.

The position of switch 2 is not limited to a certain place on the seat cushion cover 1. It can be set at any position on the seat cushion cover 1.

The filler 7 is preferably filled with cotton. It should be noted that it is not necessarily cotton. It may be an inflatable cushion or other various fillings.

The temperature adjustment button 4 can control the gravity-sensing heating plate 5, so that the seat cushion can achieve the effect of manual control of heating. When the on/off button 3 is pressed, the manual mode can be adjusted to the automatic mode. After a person sits on it, press the pressure thin film 6, the gravity-sensing heating plate 5 can be heated. When the person leaves, the pressure thin film 6 cannot feel the pressure, and it enters a non-heating state.

The gravity-sensing heating plate 5 provides three different temperature gears, which can be switched through the temperature adjustment button 4.

The thickness of the pressure thin film 6 is <=0.65 mm, response point: 80 g, durability: >1 million times, initial resistance: >10 mΩ (no load), working voltage: 0V-20V, working current: 0-50 mA, response time: <1 ms, recovery time: <15 ms, working temperature: −20° C.-60° C. The port type is a hot melt joint or equivalent material capable of completing heating and The startup parameter is 80 G.

The light assembly 8 is provided on the top of the switch 2. The light assembly 8 includes a white light 81 and a temperature light 82. The white light 81 and the temperature light 82 are both installed on the top of the switch 2.

The bottom of the switch 2 is provided with a power interface 9, wherein the power interface 9 has a wire, and the power interface 9 is used to connect to an external power supply to realize the power supply function, the power interfaces not limited to USB interfaces, type C, DC and other interfaces.

The shape of the seat cushion cover 1 is one of square, rectangle, circle, and triangle. The shape of the seat cushion cover 1 not limited to square, rectangle, circle, triangle, and can be in any shape.

The exterior of the seat cushion cover 1 is provided with a waterproof coating.

The working principle of the switchable mode gravity induction heating seat cushion provided by this invention is as follows:

The setting of switch 2 is used to turn on and switch modes. The initial state is manual mode. Press the on/off button 3 to switch from manual mode to automatic mode. In manual mode: white light 81 does not light up, and temperature light 82 lights up. At this time, press the temperature adjustment button 4 to adjust the three temperature settings of low, middle and high, and start using the heated seat cushion; automatic mode: in the standby state, the white light 81 is on, and the temperature light 82 is off. At this time, the seat cushion is in a pressure-free state, and the three settings of low, middle and high are adjusted. Temperature, select the gear, and the pressure switch is triggered when the person sits on it. At this time, the temperature light 82 lights up, and the temperature is the corresponding gear temperature. The heated seat cushion is started to be used. In the automatic mode, the person leaves the seat cushion, that is, there is no pressure on the seat cushion. Finally, the temperature lamp 82 goes out after a short period of time, and then enters the non-heating state.

Compared with the related techniques, a switchable mode gravity-sensing heated seat cushion provided by the present invention have the following beneficial effects:

The seat cushion heating is started through gravity induction. As soon as a person sits on it, the pressure switch is triggered, and the seat cushion begins to heat. When the person leaves the seat cushion, that is, after there is no pressure on the seat cushion, it enters a non-heating state. This can avoid manual forgetting to turn it off, avoid power loss, and can to switch between manual adjustment and automatic induction adjustment, the manual and automatic modes are distinguished through the change of the indicator light assembly 8 on the switch 2, thereby making it more convenient to use the seat cushion.

In another embodiment of the disclosure, The switchable mode gravity-sensing heated seat cushion also include a backrest, which contains a foldable heating pad integrated with the pressure thin film 6 of the gravity-sensing heating plate 5.

The above descriptions are only examples of the present invention, and do not limit the patent scope of the present invention. Any equivalent structure or equivalent process transformation made by using the contents of the description and drawings of the present invention, or directly or indirectly used in other applications Relevant technical fields are similarly included in the scope of patent protection of the present invention.

What is claimed is:

1. A switchable mode gravity-sensing heated seat cushion characterized by:
seat cushion cover; switch and gravity-sensing heating plate.
Switch is arranged on the seat cushion cover, There is an on/off button on the switch, similarly, there is a temperature adjustment button on the switch;
Gravity-sensing heating plate is arranged in the seat cushion cover, There is an pressure thin film in the seat cushion cover, Said pressure thin film located at the bottom of the gravity-sensing heating plate, Said seat cushion cover is filled with filler.

2. The switchable mode gravity-sensing heated seat cushion according to claim 1, wherein the top of the switch is equipped with an indicator light assembly, The indicator light assembly includes a white light and a temperature light, and both the white light and the temperature light are installed on the top of the switch.

3. The switchable mode gravity-sensing heated seat cushion according to claim 1, wherein The bottom of the switch is provided with a power interface.

4. The switchable mode gravity-sensing heated seat cushion according to claim 1, wherein The shape of the seat cushion cover is one of square, rectangle, circle, and triangle.

5. The switchable mode gravity-sensing heated seat cushion according to claim 1, wherein the exterior of the seat cushion cover is provided with a waterproof coating.
